(19) United States
(12) Patent Application Publication
(10) Pub. No.: US 2007/0071262 A1
(43) Pub. Date: Mar. 29, 2007

(54) Method for adjusting a hearing apparatus on the basis of biometric data and corresponding hearing apparatus

(76) Inventor: Uwe Rass, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/527,214

(22) Filed: Sep. 26, 2006

(30) Foreign Application Priority Data
Sep. 27, 2005 (DE) 10 2005 046 168.9

(51) Int. Cl. H04R 5/02

(52) U.S. Cl. 381/309

(57) ABSTRACT

The adjustment of hearing apparatuses and in particular hearing devices is to be improved. To this end, provision is also made to use biometric data relating to the user of the hearing apparatus. The skin resistance value is used here for instance to correspondingly control the interference noise suppression and the amplifier of a hearing device. This allows the emotional state and/or stress levels of the hearing device wearer to be better considered for the amplification and/or signal processing of the hearing device.

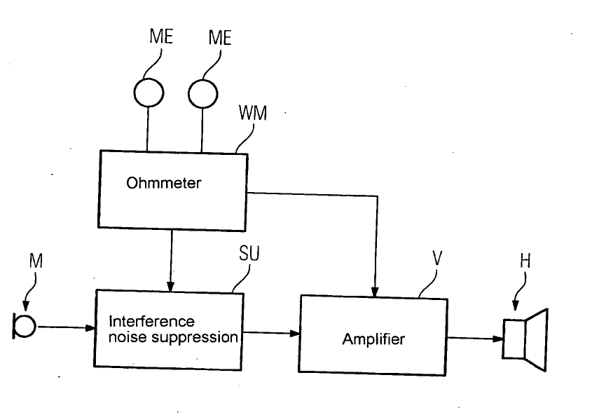

### CROSS REFERENCE TO RELATED APPLICATIONS

This application claims priority of German application No. 10 2005 046 168.9 filed Sep. 27, 2005, which is incorporated by reference herein in its entirety.

### FIELD OF THE INVENTION

The present invention relates to a method for adjusting a hearing apparatus, and in particular a hearing device. Furthermore, the present invention relates to a corresponding hearing apparatus with a sensor facility for acquiring biometric data relating to the user of the hearing apparatus.

### BACKGROUND OF THE INVENTION

It can be advantageous for the automatic adjustment of the hearing device, if the hearing device receives a feedback from the user. If the user adjusts the volume control or the program switch of the hearing device in specific audio situations, these activations can be registered and further processed by the hearing device. Volume adjustments of this type can be learned for instance and can be reused for a similar audio situation. This automatic learning takes place according to a purely objective point of view and does not account for subjective fluctuations in the state of mind. By way of example, on one given day the volume setting of the hearing device can be perceived to be pleasant for the hearing device wearer, whereas on the next day, this volume setting can be perceived to be unpleasant despite the same input sound level.

### SUMMARY OF THE INVENTION

The object of the present invention is thus to improve the automatic adjustment options for a hearing apparatus and/or hearing device.

The idea underlying the invention is also to use biometric data for the automatic adjustment of the hearing apparatus, said biometric data mirroring the state of mind of the user.

In this context, the publication JP 2002-143103 A discloses the measurement of biometric data with the aid of a hearing device. This biometric or body data, such as temperature, blood pressure and pulse, is passed on to an external device. The hearing device thus serves here to ensure precise data acquisition. The body data however does not serve to adjust the hearing device.

The above-described object is achieved in accordance with the invention by a method for adjusting a hearing apparatus, in particular a hearing device, by means of acquiring biometric data relating to the user of the hearing apparatus and adjusting at least one parameter of the hearing apparatus as a function of the acquired biometric data.

Furthermore, provision is made in accordance with the invention for a hearing apparatus, in particular a hearing device, with a sensor facility for acquiring biometric data relating to the user of the hearing apparatus, and an adjustment facility, to which the sensor facility is connected, for the automatic adjustment of at least one parameter of the hearing apparatus as a function of the acquired biometric data.

It is thus advantageously possible to automatically adjust a hearing apparatus and/or hearing device according to the subjective emotional state of the user. This allows the user to avoid any potential subsequent adjustment, which is brought about by purely individual feelings. The automatic adjustment of the hearing device does not only use measurement variables which relate to the acoustic audio situation, but also uses variables which mirror the subjective emotional state.

A sound from the hearing apparatus is preferably presented to the user immediately before or during the acquisition of biometric data. The biometric data then provides information about the state of the user. If the user perceives the sound presented to be stressful, his/her pulse increases.

In special embodiments, the skin resistance, the temperature, the blood sugar, the blood oxygen content and/or the pulse of the user can be measured as biometric data. The hearing apparatus can be adjusted to varying degrees using a corresponding plurality of measurement values.

A frequency response, the volume and/or a noise suppression of the hearing apparatus can be adjusted as a function of the biometric data. This allows account to be taken of whether the user perceives an amplified sound as pleasant or as unpleasant.

Furthermore, a rhythm of a presented piece of music or piece of music to be presented can be adjusted as a function of the pulse of the user. This allows the user to be gradually brought into a specific status, a resting state for instance.

Furthermore, it can be advantageous to generate at least one control signal as a function of the biometric data in the hearing apparatus and to transmit said control signal to an external device. This also allows the emotional state determined by way of the hearing apparatus to be used to control external devices.

### BRIEF DESCRIPTION OF THE DRAWINGS

The present invention is now described in more detail with reference to the appended drawing, which shows a schematic diagram of a hearing device according to the invention.

### DETAILED DESCRIPTION OF THE INVENTION

The exemplary embodiments illustrated in more detail below represent preferred embodiments of the present invention.

The part of the hearing device worn in the ear or on the head (BTE, ITE or ear mold of a BTE) contains measuring equipment for the skin resistance, the temperature, the blood pressure, the blood oxygen content and/or the pulse. In the example shown in the Figure, the skin resistance is measured by way of two metal electrodes ME or by way of conductive plastics on the exterior side of the housing. An ohmmeter WM determines the skin resistance from the measurement signals. The resulting resistive signal now serves to control classical signal processing facilities of the hearing device. In the present example, the interference noise suppression unit SU and the amplification unit V are controlled using this resistive measurement signal.

Four possible applications are illustrated below, in which a biofeedback of a hearing device can be used:

a) Monitoring the Stress State from the Parameters of Biosignals and an Acoustic Signal:

Depending on the state of the user, parameters of the hearing device, such as the frequency response, volume, interference noise suppression and suchlike can be adjusted. The aim here is to reduce stress. Stress can arise for instance in a noise-filled environment, if an attempt is made to concentrate on a noise-generating partner. By way of example, the skin resistance is used as a measure for the stress to which the hearing device wearer is exposed. In the hearing device, an interference noise suppression of the input sound recorded by a microphone M is then carried out as a function of the skin resistance. The amplifier V and thus the volume is likewise adjusted on a receiver H of the hearing device in a stress-dependent manner, in other words as a function of the skin resistance.

b) Medical Training Mode:

The parameters of the biosignals are mapped onto an acoustic signal which is reproduced in the hearing device. For example, the pulse is displayed in an audible manner for the hearing device wearer by a rhythm of a piece of music. The user's task is now to slow down the rhythm in order to relax for instance. A relaxation exercise of this type is of interest to cardiac infarction patients. The pulse of athletes can be monitored in this way, with the signal being a musical note for instance, the playback speed of which is changed. In this way, the pieces of music can either be stored in the hearing device itself or in an external unit (e.g. MP3 player). The above-mentioned rhythm which changes according to the pulse can furthermore also be used for cardiac coherence training. In this method, the heart beat synchronizes with the rhythm presented.

c) Adjustment Assistance:

Patient information can be stated more precisely during the adjustment of the hearing devices by including the parameters of the detected biosignals. The biosignals provide the opportunity to measure the psychoacoustic variables in an objective manner (e.g. the loudness, sharpness, audio stress etc.).

d) Control of External Devices:

The parameters of the biosignals, which are potentially combined with acoustic parameters, are used to control external devices. To this end, the hearing device transmits the detected signal parameters to a receiving unit (e.g. a notebook or PDA) in a wireless manner. The signals are evaluated in the receiving unit and are converted into actions. Examples of this application are: operation of a telephone, television remote control, wheelchair control, control of artificial, electrically operated prostheses etc.

1-9. (canceled)

10. A method for adjusting a hearing apparatus, comprising:
acquiring a biometric data of a user of the hearing apparatus; and
adjusting a parameter of the hearing apparatus as a function of the acquired biometric data.

11. The method as claimed in claim 10, wherein a sound from the hearing apparatus is presented to the user immediately before or during the acquisition of the biometric data.

12. The method as claimed in claim 10, wherein the biometric data of the user is selected from the group consisting of: a skin resistance, a temperature, a blood sugar level, a blood oxygen content, and a pulse.

13. The method as claimed in claim 10, wherein the parameter of the hearing apparatus is selected from the group consisting of: a frequency response, a volume, and a noise suppression.

14. The method as claimed in claim 10, wherein a rhythm of a piece of music which is currently presented or to be presented to the user by the hearing apparatus is adjusted as a function of a pulse of the user.

15. The method as claimed in claim 10, wherein a control signal is generated in the hearing apparatus as a function of the biometric data and transmitted to an external device.

16. The method as claimed in claim 10, wherein the hearing apparatus is a hearing device.

17. A hearing apparatus, comprising:
a sensor which acquires a biometric data of a user of the hearing apparatus; and
an adjustment device which connects with the sensor and automatically adjusts a parameter of the hearing apparatus as a function of the acquired biometric data.

18. The hearing apparatus as claimed in claim 17, wherein the hearing apparatus comprises two conductive plastic segments for measuring a skin resistance of the user.

19. The hearing apparatus as claimed in claim 17, further comprising a control device which is automatically adjusted by the adjustment device and controls an external device.

20. The hearing apparatus as claimed in claim 19, wherein the external device is selected from the group consisting of: a telephone, a television, a wheelchair, and an electrically operated prosthesis.

21. The hearing apparatus as claimed in claim 17, wherein the hearing apparatus monitors a stress status of the user from the biometric data.

22. The hearing apparatus as claimed in claim 17, wherein the hearing apparatus is a hearing device.
